(19) United States
(12) Patent Application Publication
(10) Pub. No.: US 2007/0172329 A1
(43) Pub. Date: Jul. 26, 2007

(54) Theft abating stud and nut assembly for joining flanges of members of a fluid flow conduit

(76) Inventor: Louis J. Wardlaw, Houston, TX (US)

Correspondence Address: Beirne, Maynard & Parsons, L.L.P.;Ste. 2500, 1300 Post Oak Blvd., Houston, TX, 77056-3000, US

(21) Appl. No.: 11/339,425

(22) Filed: Jan. 25, 2006

(51) Int. Cl. F16B 39/00

(52) U.S. Cl. 411/81

(57) ABSTRACT

A theft abating stud and nut assembly is provided for use on flanges of members of a fluid flow conduit, such as oil well production conduits, pipelines, and the like. Tapered smooth outer surface nuts are used with studs which are assembled by placing the studs in tension during assembly on the flanges. A method for such assembly is also disclosed.

### BACKGROUND OF THE INVENTION

1. Field of the Invention

The invention relates to a theft abating combination stud and nut assembly for affixation in openings around flanges on fluid flow conduits, such as oil field well head Christmas trees, refinery conduits, gas production pipe lines, and the like.

2. Brief Description of the Prior Art

Oil well Christmas trees are quite common on inland as well as offshore oil and gas wells. These assemblies are securely mounted at the top of the well and provide a number of valves and similar components to permit safe but controlled release of produced hydrocarbon constituents within the well and may be manipulated to close off such production and other fluids for safety or other purposes.

In some remote locations throughout the world, the Christmas trees on the wells are targets for thieves, who would cannibalize the Christmas trees and sell the valves and other parts on the black market. Typically, since the valving components making up the Christmas tree are secured one to another through housings or conduits having metallic outwardly extending flange members, such flange members are typically secured one to another using a series of threaded nut and bolt assemblies. There is a slight gap between the flange members, even when they are tightly secured one to another, because of a seal face around the interior of the flange, which actually seals the flanged members together, to avoid escape of producing fluids, or the like.

FIG. 2 is an illustration of a typical prior art flange engagement system A. The system A consist of upper and lower flange members B and C which have a series of radically and vertically disposed bores B-1 and C-1 (FIGS. 5 and 6) there through for aligning introduction of conventionally threaded studs E. The studs E are secured to the flanges B, C by means of first and second companionly threaded nut members F. The nut members each have a series of angled face members G for application of a field wrench (not shown) to apply torque to close a gap age between respective interfaces of the flange members B, C.

As will be appreciated, all that a potential thief need do to remove the flanges B, C one from another, is to place a similar wrench over each of the nuts F and apply an opposing torque to remove the nuts F from the studs E and separate the flange members, thereafter removing whatever valve component is desired to be stolen. The result of this action is not only the loss of the valve component, but the resultant loss of the integrity of the Christmas tree to control the well, as well as the loss of production from the well and, in turn, possible contamination of the surrounding areas with oil and/or gas, and possible pollution of rivers, streams and other waters nearby.

The above-described problem is equally applicable to fluid flow conduits other than Christmas trees, such as refinery conduits, oil and gas production conduits and pipelines, and any other fluid flow conduit where members are joined together with flange components affixed to one another by conventional nuts and studs.

The present invention addresses the problems associated with conventional prior art assemblies by providing a combination nut and bolt theft abatement system.

### SUMMARY OF THE INVENTION

The present invention is directed to a theft abating combination stud and nut assembly for affixation in openings around first and second flanges of joining members of a fluid flow conduit assembly. The fluid flow conduit assembly may include an oil field Christmas tree, comprised of valves, meters and controls of various sorts, hydrocarbon pipelines, flange assemblies on numerous fluid flow conduits found in refineries and other fluid flow conduit assemblies incorporating flange members which are secured one to another by the use of a plurality of studs and bolts and where it is desirable for safety and or security reasons to assure the securement of the flanges against efforts by thieves or the like to disengage and remove the studs and nuts to disengage the flanges, for whatever may be the objective of the thief, or other unauthorized person.

A combination stud and nut assembly comprises an elongated stud member, including an external circumferentially defined threading system thereon, and further including first and second ends thereof. The stud member is made of a metal, plastic or other solid component which permits the stud to be placeable into tension during affixation. An outer central section length of the threaded stud member is hardened, preferably to at least from between about 55 and about 65 Rockwell C hardness, with at least a part the central section length being placeable between the first and second flanges upon affixation of the assembly onto the flanges.

The combination stud and nut assembly further comprises first and second nut members, each having an internal threaded system for companion inter engagement with the threading system along the stud member as the nut members are secured onto the stud member. The nut members each include first and second ends thereon and further include a smooth conically tapered outer surface extending from the first end to the second end.

In a preferred embodiment, at least one tensioning cavity may be defined on the outer surface of each of the nut members for insertion of an adjusting pin, or the like, for tightening of the nut members onto the stud member as the stud member is placed in tension during the affixation. The tightening of the nut member through use of the adjusting pin is accomplished by placing the stud in tension to slightly elongate the stud within the elastic limits of its composition so that the nut may be moved toward engagement position on the flange member without application of torque to either the stud or nut members. Of course, the invention need not include such alternative preferred embodiment. It is only preferable to provide any means for moving the nut toward the flange as tension is applied to the stud. For further example, epoxy or other similar hex or similarly designed flats could be cast or otherwise secured onto the exterior of the conical nuts, and a wrench applied upon them to move the nut toward the flange during installation. Thereafter, the flats could be broken off or otherwise removed from the exterior of the nuts.

Alternatively, the flats could be left in place after installation and, if thievery is not undertaken thereafter and the flats removed during theft, the flats could be used to remove the nuts if the flanges are to be disengaged from one another by a legitimate engineer or other authorized personnel.

Alternatively, the invention could be designed such that no such means are needed and the nut is permitted, for example, to simply gravitate toward the flange during the securement process, as tension is applied to the stud to elongate the stud within the elastic limits of its composition.

In another preferred embodiment, the stud and nut combination assembly provides for a series of slots defined on the inner face of said flanges, with the slots on the inner face of one of the flanges being vertically alienable with each of the slots on the inner face of the other of the flanges. Metallic bridge means are then insertable within the slots and disposed at least partially across the diameter of the lugs extending between the flanges, to resist sawing or hacking of a length of the stud at a point in between the flanges.

In yet another preferred embodiment, the flanges provide inner and outer faces and the assembly further comprises a circumferentially extending groove way defined on each of said inner faces of said flanges and outboard of the openings in said flanges. A metallic bridge means is houseable in the groove way for resisting cutting or hacking of the studs during attempted theft.

The present invention is also directed to a method for theft abatement of flanges joining members of a fluid flow conduit. A combination stud and nut assembly, as described herein, is provided. The flange members are oriented to align the openings with one another. A stud member is introduced into one of the flange openings. Each of the first and second nut members are sequentially threadingly engaged onto the respective ends of the stud member. Tension is then applied through the stud member to increase the length of the stud member sufficient to elongate the stud within the elastic limits of its composition. The control rod is introduced into at least one of the cavities on at least one of the nuts to manipulate said at least one of the nuts further toward the flanges to secure the nuts to the stud member and upon the flanges in at least hand-tight relationship. Tension is then released through the stud so that the stud thread members and the nut members become lockingly inter engaged and the stud member is in a secured position relative to the flange members. The steps are repeated, as required, in sequential incremental steps around the remaining openings of the flange members.

### BRIEF DESCRIPTION OF THE DRAWINGS

FIG. 1 is an illustration, in perspective, of a conventional oil field Christmas tree, with both a conventional stud and nut assembly in place, as well as the stud and nut assembly of the present invention.

FIG. 2 is an enlarged PRIOR ART perspective view of the conventional stud and nut affixation assembly for flange members of a valve assembly on an oil field Christmas tree, as illustrated in FIG. 1.

FIG. 3 is a view similar to that of FIG. 2 illustrating the slug and nut assembly of the present invention in completely affixed and secured position relative to flange members.

FIG. 4 is a perspective illustration of the positioning of a tensioning cell over the slug and nut combination of the present invention as shown in FIG. 3.

FIG. 5 is a perspective and cross-sectional view of the slug and nut combination of the present invention and including a preferred embodiment of metallic bridge means insertable within slots on each of the flanges.

FIG. 6 is a perspective view looking downward, illustrating an alternate preferred embodiment of the bridging means within a groove on the lower flange members.

FIG. 7 is a perspective view of the nut member of the present combination showing the internal thread system for same, as the slug is placed in tension.

FIG. 8 is a perspective illustration of yet another embodiment of the invention, showing a stud where a section thereof is not threaded, as well as yet another embodiment of such a stud wherein a centrally offset section is bored to receive a hardened slug, or a hardened facing section, which is rotated to face outwardly and which, when so positioned, resists sawing to cut the stud.

FIG. 9 is a view similar to FIG. 8, illustrating yet another embodiment, wherein the cavity 23 is replaced by a flat 70, secured to the outer surface of the conical nut by epoxy, or the like.

FIG. 10 is a view similar to that of FIG. 9, illustrating the removal of the flat 70 after installation, leaving a marked surface 71 in place thereof.

### DETAILED DESCRIPTION OF THE PREFERRED EMBODIMENT

Now, with first reference to FIG. 1 (PRIOR ART) there is shown a conventional oil well Christmas tree CT which includes a series of valve housings VH.

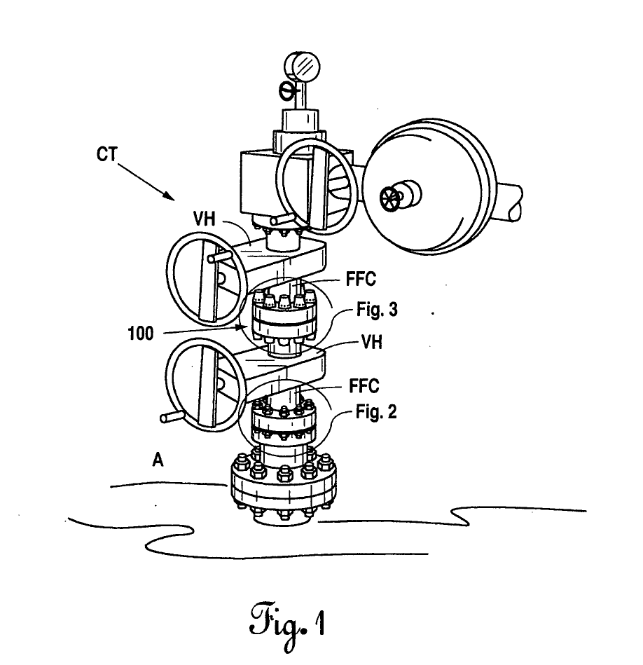

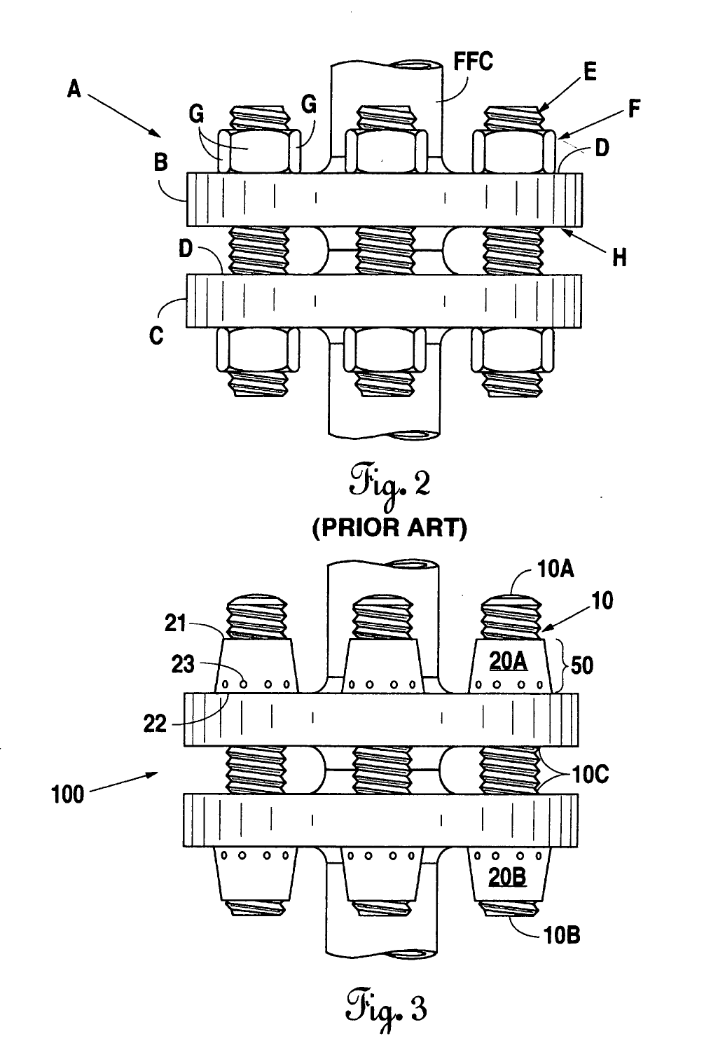

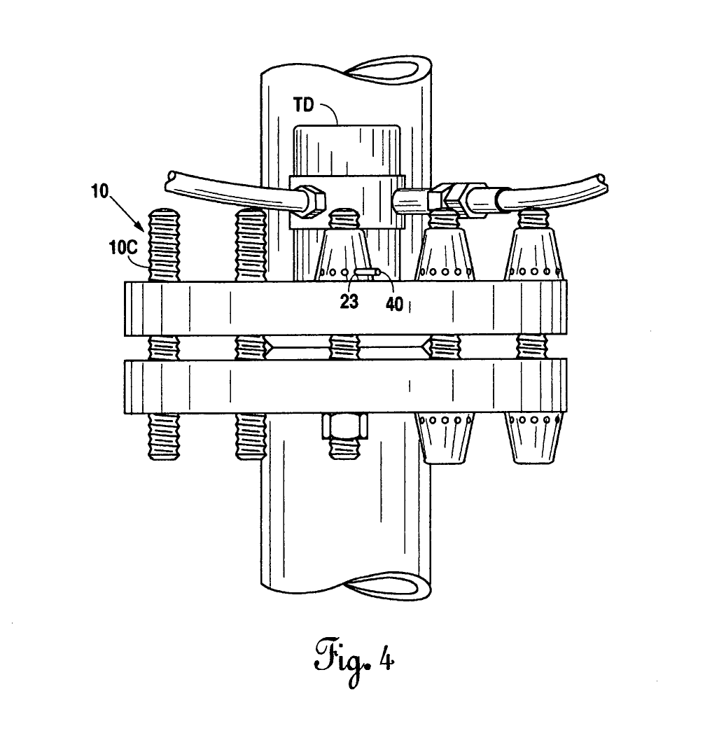

As further detailed in FIG. 2 (PRIOR ART) the valve housings VH each have a fluid flow conduit FFC centrally disposed there through. The valve housings VH have flanges at each end thereof. FIG. 2 illustrates the conventional joinder of two valve housings VH including the lower flange B of the upper valve housing VH and the upper flange C of a lower housing VH. As connected, the flanges B, C are secured together, but there is a slight gap or height H there between which disposes to view a short intermediate sectional length of a conventionally threaded nut E. The height H would enable a would-be thief to introduce a hack or other saw or other element between the flanges B and C to fairly easily cut each of the studs E for the removal of components of the Christmas tree CT.

Also, as illustrated in FIG. 2, a conventional internally threaded nut member F is illustrated as torqued to tight engagement on the outer face D of the respective flange faces B and C. The conventional nut F will have a series of circumferentially extending faces G in a plurality of configurations, such as hexagonal, octagonal, or the like. These faces G and their angular positioning around the exterior of the conventional nut F enable a torque wrench to be affixed to the nut to rotate the nut off of the upper end of the stud E for removal of the stud E from secured position on the flanges B and C. This step could be repeated for the plurality of stud and nut combinations secured around the flanges B and C.

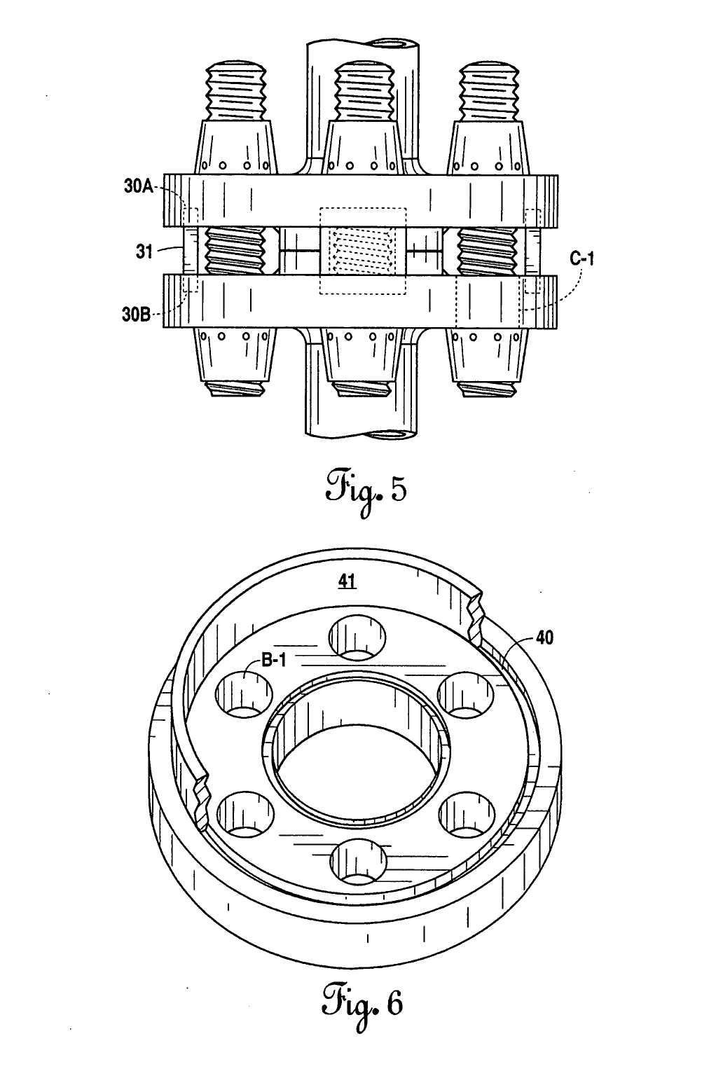

Now referring to FIG. 3, there is shown the stud and nut assembly 100 of the present invention in fixed position onto the flange assembly A, as shown in FIGS. 1 and 2. The conventional studs E and nuts F have been removed from the bores or holes B-1 (FIG. 6) disposed and aligned in each of the flanges B and C. The stud 10 has an upper end 10A and a lower end 10B. The stud 10, has an outer central section length 10C which will have a hardness substantially greater than that for the balance of the length the stud 10 between the upper and lower ends 10A and 10B. Preferably, the section length 10C will have a Rockwell C hardness to at least from between about 55 and about 65.

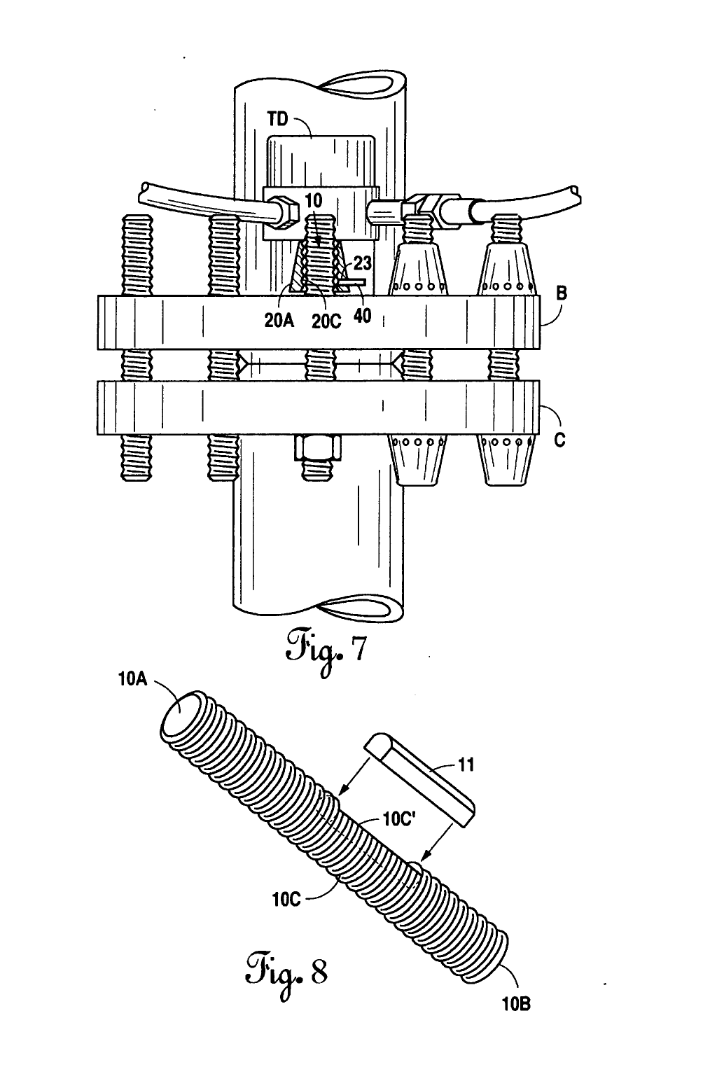

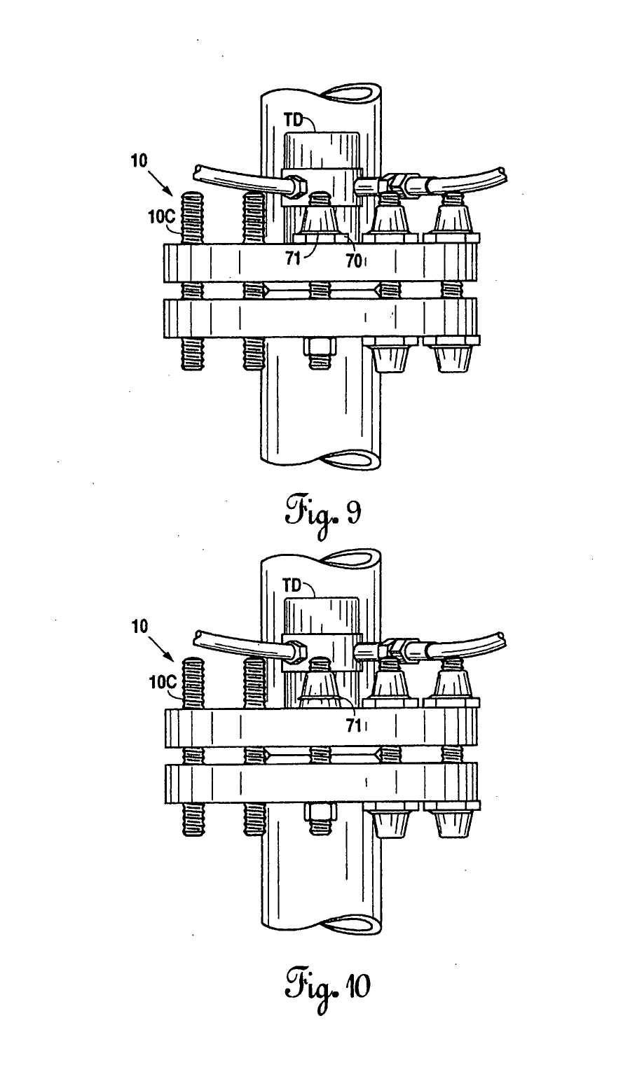

The combination stud and nut assembly 100 further comprises first and second nuts 20A and 20B. Each of the nuts 20A and 20B has an internal threading system 20C (FIG. 7) for companion inter-engagement with the threading system 10C (FIG. 3) of the stud 10.

Each of the nuts 20A, and 20B have first and second ends thereof, 21 and 22, respectively. One of the ends, preferably the upper end 21, has a diameter which is smaller than the larger diameter for the other of the ends, such as the lower end, 22, such that the respective nuts 20A and 20B are provided in a smooth conically tapered outer surface 50 extending from the respective ends 21 and 22. The taper 50 provides a smooth outer surface of the respective nuts 20A and 20B, which do not have a plurality of faces thereon, such as the hexagonal or octagonal faces G of the conventional nuts F shown in FIG. 2. By providing such a smooth, conically tapered outer surface 50, a wrench cannot be used to loosen the nuts 20A, 20B by application of torque while the stud is in tension. The nuts 20A and 20B may also be hardened, preferably to from between about 55 and about 65 Rockwell C hardness.

In a preferred embodiment the nuts 20A, 20B also include at least one torquing cavity 23 defined on the outer surface of each of the nut members 20A, 20B for insertion of an adjusting pin 40 for tightening of said nut members onto the stud members 20A and 20B as the stud members are placed into tension during affixation. It will be appreciated that, upon completion of the affixation of the nuts 20A, 20B onto the studs, the stud will remain somewhat in tension, even though the interengaging threads between the nuts and the studs are in engaged position. Such tensioning of the stud in securement relative to the nuts will further resist application of torque to the nuts and/or the stud to disengage same.

FIG. 5 illustrates another preferred embodiment showing a series of slots 30A and 30B provided in each of the flanges B and C for receipt of metallic bridge means 31 therein. The slots 30B and 30C are alignable on the respective upper and lower internal faces of the respective flange members B and C such that the bridge means 31 is inserted in the slots 30B and 30C during securement or the nut means 20A, 20B onto the nuts 10 and the bridge means are disposed at least partially across that diameter of respective stud E extending between the flanges B and C.

An additional preferred embodiment is shown in FIG. 6, where a groove way 40 is circumferentially extended and defined on each of the inner faces of the flanges B and C an outboard of the openings for the fluid conduit member. A solid, circularly extending metallic bridge means 41 is housed between the groove ways for resisting cutting of the studs E during attempted theft of the Christmas tree CT.

Now, with reference to FIG. 8, the stud 10 may be provided with an unthreaded section 10C, which may be hardened to from between about 55 and about 65 Rockwell C. This section 1OC would be designed such that it is placed between the flanges B and C during securement. Also, as shown in FIG. 8, a rectangular or other configured slot 10C′ may be bored into a part of the unthreaded section 10C to slip into place a companionly snug fitting hardened slug 11. The slug 11 may be welded into place and may be of tungsten or other comparatively hard material. As illustrated, the slot 10C′ and slug 11 may be provided in less than a completely radial configuration, such that, for example, the slug 11 is only within, say, about 90 degrees of a complete 360 degree surface area of the portion 10C. In such case, when the stud 10 is placed between the flanges B and C, the slug 11 may be hand manipulated to turn it such that the slug 11 faces outwardly around the flanges A and B, to further resist sawing or other attempt at removing the stud 10.

When it is desired to use the combination stud and nut assembly of the present invention for theft abatement purposes, the conventional nuts F are removed by application of a torque wrench to the respective studs E around the flanges B and C. They are then replaced using the stud 10 of the present invention, with a central section 10C being aligned between the upper and lower internal faces of the flanges B and C. A nut 20A is hand rotated onto the upper end 10A of the stud 10 until its lower face comes into contact with the upper face of the respective flange member B, C. The steps are repeated with the other of the nuts 20B on the other of the flanges B and C. Thereafter, the nut 10 is placed into tension.

There are a number of conventional tensioning devices TD well known to those skilled in the art which may be utilized by providing a sleeve for the tensioner (not shown) which has internal threads which are companionly inter-engageable with the threads 10C of the stud 10. The sleeve would be placed over the stud 10 with an open end of the sleeve being placed on the upper face of the respective flange B, or C and hydraulically activated to apply tension to the stud 10 to elongate the stud within the elastic limits of its composition. While the stud 10 is placed in tension, a control rod is placed into one of the cavities 23 so that the stud 20A, 20B may be manipulated by hand so that it is hand-tight onto the upper surface of the respective flange B or C. When in tension, the respective threads of the slug will still be slightly engaged with the internal companion threads of the nut 20A, 20B, even though the stud 10 has been placed in tension and thus elongated. Tension applied to the stud 10 may now be released , but the stud 10 remains in tension due to the continued and further inter-engagement of the threads of the slug and those of the nut, and the tensioned stud and nut combination 100 are tightly secured against the respective flanges B and C.

It will be appreciated that the length of the stud 10 used to replace the conventional prior art stud E may be somewhat longer than the stud E, in order to provide for acceptance of a sleeve or other component of the tensioning device TD (see FIG. 7).

While the foregoing is directed to the preferred embodiment of the present invention, other and further embodiments of the invention may be devised without departing from the basic scope thereof, and the scope thereof is determined by the claims which follow.

What is claimed and desired to be secured by Letters Patent is:

1. A theft abating combination stud and nut assembly for affixation in openings around first and second flanges of joining members of a fluid flow conduit assembly, comprising:
(a) an elongated stud member including an external circumferentially defined threading system thereon and further including first and second ends thereof, said stud member being placeable into tension during and subsequent to said affixation;
(b) an outer substantially central section length of said threaded stud member hardened to at least from between about 55 and about 65 Rockwell C hardness, at least a part of said substantially central section length being placeable between the first and second flanges upon affixation of the assembly onto said flanges;
(c) first and second nut members, each having an internal threading system for companion inter engagement with the threading system along said stud member as the nut members are secured onto the stud member, said nut members each including first and second ends thereon and further including a smooth conically taped outer surface extending from said first end to said second end; and
(d) at least one tensioning cavity defined on said outer surface of each of said nut members for insertion of an adjusting pin for tightening of said nut members onto said stud member as said stud member is placed in tension during said affixation.

2. A theft abating flange assembly, comprising:
(a) first and second flange members, each of said flange members having a series of circumferentially extending openings there through;
(b) a plurality of elongated stud members for positioning within each of said openings for securement of said flanges together, each of said stud members including an external circumferentially defined threading system thereon and further including first and second ends thereof, each of said studs being placeable into tension during and after securement of said flanges;
(c) an outer substantially central section length of each said threaded stud member being hardened to at least from between about 55 and about 65 Rockwell C hardness, at least a part of said substantially central section length being placeable between the first and second flange members upon securement of the stud members onto said flange assembly;
(d) first and second nut members for placement on the ends of each stud member, each said nut member having an internal threading system for companion inter engagement with the threading system along said stud members as the nut members are secured onto the respective stud members, said stud members each including first and second ends thereon and further including a smooth conically tapered outer surface extending from said first end to said second end; and
(e) at least one torquing cavity defined on the outer surface of each of said nut members for insertion of an adjusting pin for tightening of said nut members onto said stud members as said stud members are placed into tension during said affixation.

3. A method for theft abating affixation of first and second flanges of joining members of a fluid flow conduit, said flanges having flange members having a series of circumferentially disposed openings there through, comprising:
(1) providing a combination stud and nut assembly, comprising:
(a) elongated stud members for positioning within each of said openings for securement of said flanges together, each of said stud members including an external circumferentially defined threading system thereon and further including first and second ends thereof, each of said studs being placeable into tension during and after securement of said flanges;
(b) an outer substantially central section length of each said threaded stud member being hardened to at least from between about 55 and about 65 Rockwell C hardness, at least a part of said substantially central section length being placeable between the first and second flange members upon securement of the stud members onto said flange assembly;
(c) first and second nut members for placement on the ends of each stud member, each said nut member having an internal threading system for companion inter engagement with the threading system along said stud members as the nut members are secured onto the respective stud members, said stud members each including first and second ends thereon and further including a smooth conically tapered outer surface extending from said first end to said second end; and
(d) at least one torquing cavity defined on the outer surface of each of said nut members for insertion of an adjusting pin for tightening of said nut members onto said stud members as said stud members are placed into tension during said affixation;
(2) orienting said flange members to align the openings in the first flange member with the openings in the second flange member;
(3) introducing a stud member into one of said flange openings;
(4) threadingly engaging each of said first and second nut members onto the respective ends of said stud member:
(5) applying tension through said stud member to elongate said stud member to no more than the elastic limits of the composition of said stud member, and whereby said first and second nut members continue to be in threaded inter-engagement with said stud member;
(6) introducing a control rod into at least one of said cavities on at least one of said nuts to manipulate each of said nuts further toward said flanges to secure said nuts to said stud member and upon said flanges in at least hand-tight relationship;
(7) reducing the tension applied through said stud such that the thread members of said stud member and said nut members become lockingly inter engaged and the stud member remains in tension and in a secured position relative to said flange members; and
(8) repeating steps (2) through (7), as required, in sequential incremental steps around the remaining openings of said flange members.

4. The assembly of claim 1 wherein said flanges each have inner and outer faces, and said assembly further comprises: a series of slots defined on each inner face of said flanges, each of said slots on the inner face of one of said flanges being vertically alignable with each of the slots on the inner face of the others of the flanges; and metallic bridge means insertable within said slots and disposed at least partially across the diameter of said studs extending between said flanges.

5. The flange assembly of claim 2 wherein said flanges each have inner and outer faces, and said assembly further comprises: a series of slots defined on each inner face of said flanges, each of said slots on the inner face of one of said flanges being vertically alignable with each of the slots on the inner face of the others of the flanges; and metallic bridge means insertable within said slots and disposed at least partially across the diameter of said lugs extending between said flanges.

6. The assembly of claim 1 wherein said flanges each have inner and outer faces, and said assembly further comprises: a circumferentially extending grooveway defined on each of said inner faces of said flanges and outboard of said openings in said flanges; and a metallic bridge means houseable in said grooveways for resisting cutting of said studs during attempted theft of said Christmas tree.

7. The flange assembly of claim 2 wherein said flanges each have inner and outer faces, and said assembly further comprises: a circumferentially extending grooveway defined on each of said inner faces of said flanges and outboard of said openings in said flanges;
and a metallic bridge means houseable in said grooveways for resisting cutting of said studs during attempted theft of said Christmas tree.

8. A theft abating combination stud and nut assembly for affixation in openings around first and second flanges of joining members of a fluid flow conduit assembly, comprising:
(a) an elongated stud member including an external circumferentially defined threading system thereon and further including first and second ends thereof, said stud member being placeable into tension during and after said affixation of said flanges of the conduit assembly;
(b) an outer substantially central section length of said threaded stud member having a Rockwell C hardness in excess of the Rockwell C hardness of the remainder of said stud member, at least a part of said substantially central section length being placeable between the first and second flanges upon affixation of the assembly onto said flanges;
(c) first and second nut members, each having an internal threading system for companion inter engagement with the threading system along said stud member as the nut members are secured onto the stud member, said nut members each including first and second ends thereon and further including a smooth conically taped outer surface extending from said first end to said second end; and
(d) at least one torquing cavity defined on said outer surface of each of said nut members for insertion of an adjusting pin for tightening of said nut members onto said stud member as said stud member is placed in tension during said affixation.

9. A theft abating combination stud and nut assembly for affixation in openings around first and second flanges on a well head Christmas tree assembly, comprising:
(a) an elongated stud member including an external circumferentially defined threading system thereon and further including first and second ends thereof, said stud member being placeable into tension during said affixation;
(b) an outer substantially central section length of said threaded stud member hardened to at least from between about 55 and about 65 Rockwell C hardness, at least a part of said central section length being placeable between the first and second flanges upon affixation of the assembly onto said flanges;
(c) first and second nut members, each having an internal threading system for companion inter engagement with the threading system along said stud member as the nut members are secured onto the stud member, said nut members each including first and second ends thereon and further including a smooth conically taped outer surface extending from said first end to said second end; and
(d) at least one torquing cavity defined on said outer surface of each of said nut members for insertion of an adjusting pin for tightening of said nut members onto said stud member as said stud member is placed in tension during said affixation.

10. A theft abating well head Christmas tree flange assembly, comprising:
(a) first and second flange members, each of said flange members having a series of circumferentially extending openings there through;
(b) a plurality of elongated stud members for positioning within each of said openings for securement of said flanges together, each of said stud members including an external circumferentially defined threading system thereon and further including first and second ends thereof, each of said studs being placeable into tension during securement of said flanges;
(c) an outer substantially central section length of each said threaded stud member being hardened to at least from between about 55 and about 65 Rockwell C hardness, at least a part of said substantially central section length being placeable between the first and second flange members upon securement of the stud members onto said flange assembly;
(d) first and second nut members for placement on the ends of each stud member, each said nut member having an internal threading system for companion inter engagement with the threading system along said stud members as the nut members are secured onto the respective stud members, said stud members each including first and second ends thereon and further including a smooth conically tapered outer surface extending from said first end to said second end; and
(e) at least one torquing cavity defined on the outer surface of each of said nut members for insertion of an adjusting pin for tightening of said nut members onto said stud members as said stud members are placed into tension during said affixation.

11. A method for theft abating affixation of first and second well head Christmas tree flanges, said flanges having flange members having a series of circumferentially disposed openings there through, comprising:
(1) providing a combination stud and nut assembly, comprising:
(a) elongated stud members for positioning within each of said openings for securement of said flanges together, each of said stud members including an external circumferentially defined threading system thereon and further including first and second ends thereof, each of said studs being placeable into tension during securement of said flanges;
(b) an outer substantially central section length of each said threaded stud member being hardened to at least from between about 55 and about 65 Rockwell C hardness, at least a part of said substantially central section length being placeable between the first and second flange members upon securement of the stud members onto said flange assembly;
(c) first and second nut members for placement on the ends of each stud member, each said nut member having an internal threading system for companion inter engagement with the threading system along said stud members as the nut members are secured onto the respective stud members, said stud members each including first and second ends thereon and further including a smooth conically tapered outer surface extending from said first end to said second end; and
(d) at least one torquing cavity defined on the outer surface of each of said nut members for insertion of an adjusting pin for tightening of said nut members onto said stud members as said stud members are placed into tension during said affixation;
(2) orienting said flange members to align the openings in the first flange member with the openings in the second flange member;
(3) introducing a stud member into one of said flange openings;
(4) threadingly engaging at lest one of said first and second nut members onto the respective ends of said stud member:
(5) applying tension through said stud member to increase the length of said stud member within the elastic limits of the composition of said stud member and whereby said first and second nut members remain in threaded inter-engagement with said stud member;
(6) introducing a control rod into at least one of said cavities on each of said nuts to manipulate each of said nuts further toward said flanges to secure said nuts to said stud member and upon said flanges in at least hand-tight relationship;
(7) reducing the tension applied through said stud such that the thread members of said stud member and said nut members lockingly inter-engage the stud and nut members to retain the applied tension within the stud member, and the stud member is in a secured position relative to said flange members; and
(8) repeating steps (2) through (7), as required, in sequential incremental steps around the remaining openings of said flange members.

12. The assembly of claim 9 wherein said flanges each have inner and outer faces, and said assembly further comprises: a series of slots defined on each inner face of said flanges, each of said slots on the inner face of one of said flanges being vertically alignable with each of the slots on the inner face of the others of the flanges; and metallic bridge means insertable within said slots and disposed at least partially across the diameter of said lugs extending between said flanges.

13. The Christmas tree flange assembly of claim 10 wherein said flanges each have inner and outer faces, and said assembly further comprises: a series of slots defined on each inner face of said flanges, each of said slots on the inner face of one of said flanges being vertically alignable with each of the slots on the inner face of the others of the flanges; and metallic bridge means insertable within said slots and disposed at least partially across the diameter of said lugs extending between said flanges.

14. The Christmas tree flange assembly of claim 10 wherein said flanges each have inner and outer faces, and said assembly further comprises: a circumferentially extending grooveway defined on each of said inner faces of said flanges and outboard of said openings in said flanges; and a metallic bridge means houseable in said grooveways for resisting cutting of said studs during attempted theft of said Christmas tree.

15. A theft abating combination stud and nut assembly for affixation in openings around first and second flanges on a well head Christmas tree assembly, comprising:
(a) an elongated stud member including an external circumferentially defined threading system thereon and further including first and second ends thereof, said stud member being placeable into tension during said affixation;
(b) an outer substantially central section length of said threaded stud member hardened to at least from between about 55 and about 65 Rockwell C hardness, at least a part of said substantially central section length being placeable between the first and second flanges upon affixation of the assembly onto said flanges and
(c) first and second nut members, each having an internal threading system for companion inter engagement with the threading system along said stud member as the nut members are secured onto the stud member, said nut members each including first and second ends thereon and further including a smooth conically tapered outer surface extending from said first end to said second end.

16. A theft abating combination stud and nut assembly for affixation in openings around first and second flanges on a well head Christmas tree assembly, comprising:
(a) an elongated stud member including an external circumferentially defined threading system thereon and further including first and second ends thereof, said stud member being placeable into tension during said affixation;
(b) an outer central substantially section length of said threaded stud member having a Rockwell hardness in excess of the Rockwell hardness of the remainder of said stud member, at least a part of said central section length being placeable between the first and second flanges upon affixation of the assembly onto said flanges;
(c) first and second nut members, each having an internal threading system for companion inter engagement with the threading system along said stud member as the nut members are secured onto the stud member, said nut members each including first and second ends thereon and further including a smooth conically taped outer surface extending from said first end to said second end; and
(d) at least one torquing cavity defined on said outer surface of each of said nut members for insertion of an adjusting pin for tightening of said nut members onto said stud member as said stud member is placed in tension during said affixation.

17. The combination of claim 1 wherein said threading system of said stud member is not disposed along said substantially central section length.

18. The combination of claim 17 wherein said stud is slotted around at least a potion of said substantially central section length and a slug is housed within slotted stud central section.

19. A theft abating combination stud and nut assembly for affixation in openings around first and second flanges on a well head Christmas tree assembly, comprising:
(a) an elongated stud member including an external circumferentially defined threading system thereon and further including first and second ends thereof, said stud member being placeable into tension during said affixation;
(b) an outer substantially central section length of said threaded stud member hardened to at least a Rockwell C hardness in excess of the Rockwell C hardness of the remainder of the length of said threaded stud, at least a part of said substantially central section length being placeable between the first and second flanges upon affixation of the assembly onto said flanges;
(c) first and second nut members, each having an internal threading system for companion inter engagement with the threading system along said stud member as the nut members are secured onto the stud member, said nut members each including first and second ends thereon and further including a smooth conically taped outer surface extending from said first end to said second end; and
(d) a plurality of circumferentially extending flat means removably secured around the exterior of each of said nut members for applying torque to said nuts to move said nuts toward engaging position relative to said respective flange, each of said flat means being thereafter removeable from said nuts.

20. A theft abating combination stud and nut assembly for affixation in openings around first and second flanges of joining members of a fluid flow conduit, said flanges having flange members having a series of circumferentially disposed openings there through, comprising:
(a) an elongated stud member including an external circumferentially defined threading system thereon and further including first and second ends thereof, said stud member being placeable into tension during said affixation;
(b) an outer substantially central section length of said threaded stud member hardened to at least a Rockwell C hardness in excess of the Rockwell C hardness of the remainder of the length of said threaded stud, at least a part of said substantially central section length being placeable between the first and second flanges upon affixation of the assembly onto said flanges;
(c) first and second nut members, each having an internal threading system for companion inter engagement with the threading system along said stud member as the nut members are secured onto the stud member, said nut members each including first and second ends thereon and further including a smooth conically taped outer surface extending from said first end to said second end; and
(d) a plurality of circumferentially extending flat means removably secured around the exterior of each of said nut members for applying torque to said nuts to move said nuts toward engaging position relative to said respective flange, each of said flat means being thereafter removeable from said nuts.

21. A theft abating combination stud and nut assembly for affixation in openings around first and second flanges of joining members of a fluid flow conduit, said flanges having flange members having a series of circumferentially disposed openings there through, comprising:
(a) an elongated stud member including an external circumferentially defined threading system thereon and further including first and second ends thereof, said stud member being placeable into tension during said affixation and remaining in tension thereafter;
(b) an outer substantially central section length of said threaded stud member hardened to a Rockwell C hardness in excess of the Rockwell C hardness of the remainder of said stud member, at least a part of said substantially central section length being placeable between the first and second flanges upon affixation of the assembly onto said flanges; and
(c) first and second nut members, each having an internal threading system for companion inter engagement with the threading system along said stud member as the nut members are secured onto the stud member, said nut members each including first and second ends thereon and further including a smooth conically tapered outer surface extending from said first end to said second end.
